(19) United States
(12) Patent Application Publication
(10) Pub. No.: US 2003/0059532 A1
(43) Pub. Date: Mar. 27, 2003

(54) Automatic machine for the extrusion and application of sealant onto the lateral walls of a spacer frame for insulated glass and automated procedure for the extrusion and application of sealant onto the lateral walls of a spacer frame for insulated glass

(75) Inventor: Fortunato Vianello, Vallio Di Roncade (IT)

Correspondence Address: MODIANO & ASSOCIATI, Via Meravigli, 16, MILANO, 20123, IT

(73) Assignee: FOR.EL. BASE DI VIANELLO FORTUNATO & C. S.n.c.

(21) Appl. No.: 10/251,892

(22) Filed: Sep. 23, 2002

(30) Foreign Application Priority Data
Sep. 27, 2001 (IT) TV2001A000131

(51) Int. Cl. B05D 7/22

(52) U.S. Cl. 427/230; 118/410

(57) ABSTRACT

The present invention relates to an automatic machine and an automated procedure for the extrusion and application of sealant onto the lateral walls of a spacer frame for insulating glass, mainly of rectangular shape yet not ruling out shapes differing from rectangular with the introduction of a specific option. An essential feature of the machine consists in that the “spacer frame”, which always results as being suspended, requires neither resting nor running bases and therefore the surfaces which have been spread with sealant will never be contaminated by any other agent.

### BACKGROUND OF THE INVENTION

The present invention relates to an automatic machine and an automated procedure for the extrusion and application of sealant onto the lateral walls of a spacer frame for insulating glass, mainly of rectangular shape yet not ruling out shapes other than rectangular with the introduction of a specific option.

An essential feature of the machine consists in that the “spacer frame”, which always results as being suspended, requires neither resting nor running bases and therefore the surfaces which have been spread with sealant will never be contaminated by any other agent.

It is well known nowadays that the so-called “butyl application” of the spacer frames for insulating glass is carried out by way of semi-automatic procedures (the “spacer frame” is drawn along by the machine yet guided by the operator during the extrusion of the sealant which is applied simultaneously on each opposite wall of the “spacer frame”) or automatic procedures (the operator's guidance during the whole procedure is unnecessary).

For a clearer understanding of the configuration and the function of the spacer frame, the following notions regarding the product known as “the spacer frame” and the semi-finished “insulating glass” (of which the spacer frame is a part of), are briefly summarised, acknowledging the subsequent use of the “insulating glass” as part of a window frame.

The “insulating glass” is formed by two or more glass sheets which are separated by one or more “spacer frames” which are hollow and microperforated along the internal face, these “spacer frames” containing hygroscopic material inside their hollow part and the chamber (or chambers) contained within the glass sheets and by the frame(s) which can contain either air or gas or a blend of gas which confers the “insulating glass” particular properties, for example thermo-insulating and/or sound-proofing. The bonding between glass and frame(s) is obtained through two levels of sealing, the first (which is the subject of the present invention), having the task of creating air/gas tightness and involving the lateral surfaces of the “spacer frame” and the adjacent part of the glass sheet, the second having the task of obtaining cohesion between the components and the mechanical resistance of the joint between the same and involving the space created by the external surface of the “spacer frame”, including the part which has been varyingly conformed as a connection between the two lateral surfaces, and by the glass faces right up to the edges of the same (see FIG. 1).

The glass used in the making of “insulating glass” can be of various structures according to its use, for example the external glass (external intended in respect of the building) can be either normal or reflective (in order to limit thermal absorption during the Summer months) or laminated/armoured (when considering cases of smash-proof or vandal-proof uses) or laminated/tempered (for safety use) or combined (for example: reflective and laminated glass to obtain a combination of properties), the internal glass (internal intended in respect of the building) can either be normal or low-emissive glass (to limit heat dispersion during the Winter months) or laminated/tempered (for safety use) or combined (for example: low-emissive and laminated to obtain a combination of properties).

From the simple summary drawn up, and in reference to the product which has been processed with the machine and/or the procedure which is the subject of the present invention, it is already evident that, in order to obtain the “insulating glass” product, a manufacturing line will require many and consequential treatments and that productivity could increase if these treatments were to be carried out automatically.

The treatments required for the production of “insulating glass”, each one requiring a related and particular machine which has to be arranged in-line in respect to the other complementary machines are, by way of an example yet not exhaustive and at the same time not all necessary, the following:

EDGE DELETION along the peripheral edge of glass sheets foreseen with any eventual coatings to allow and maintain the sealant's adhesion in time.

WASHING of each singular glass sheet, alternatively for external or internal glass sheets (the facing of which is that defined formerly).

QUALITY CONTROL electronically, automatically or visually semi-automatic.

SPACER FRAME APPLICATION: the “spacer frame” which has been previously constructed, filled with hygroscopic material and treated to the lateral faces with an adhesive sealant having air/gas tightness qualities, in machines which are independent in respect to the “insulating glass” production line (and in fact one of these machines, i.e. the machine for applying primary sealant and the related procedure which is dealt with in this application for industrial patent) is applied to one of the glass sheets which go to form the “insulating glass” through a purposeful application centre along the “insulating glass” production line.

COUPLING AND PRESSING of the combination of glass/frame(s)

FILLING WITH GAS of the chamber(s)thus obtained

APPLICATION OF SHIMMING PADS (packing component)

SECONDARY SEALING

The above-mentioned procedures, which can be handled, by each singular machine, either automatically or semi-automatically. The research for prior patents in sectors pertinent or similar has produced (other than Italian Application TV2000A000129 dated 17.10.2000 by the same inventor but referring to an inventive notion differing a great deal with that of the present invention) to the following patent in the field of automatic machinery for the application of primary sealant to the lateral faces of the spacer frame: Italian patent 1 122 818 claiming Austrian priority 6957/78 dated 26.09.78 by Lisec Peter. Said invention neither teaches nor anticipates the inventive notion which is the subject of the present invention, on the contrary the teaching is opposed in that it is that of teaching to lean a face of the “spacer frame” against an almost vertical wall (slightly tilted in respect to the vertical base) for transferring, made up essentially by motorised and close-set rollers.

The research for the known techniques other than that of the disclosed invention mentioned above, and which has lead to the machines constructed by the various manufacturers, has led to a conclusion that in all cases, should they be obtained through semi-automatic or fully automatic machinery, 1) the “spacer frame” is supported along the base, 2) the “spacer frame” leans against an almost vertical wall (slightly tilted in respect to the vertical base), 3) the spreading of the sealant (primary sealant) on the lateral walls of the “spacer frame” is carried out along the side or on the corner (during rotation of the “spacer frame”) along the lower part, 4) the sealant, after having been spread, is in contact with transferring means.

The major inherent problems with the above-mentioned techniques are the following:

difficulty in the rotation of the “spacer frame” of medium/large dimensions due to their imprecise structure and their deformability, in view of their being supported from below;

contact of the “spacer frame” face (the part which is facing the supporting wall), or better, contact of the sealant which is spread on the same side, with sliding walls, made up of motorised rollers or motorised conveyor belts, and therefore contamination or deformation of the same sealant, which by nature is thermo-plastic, sticky and still warm due to its recent extrusion;

if during the linear transfer of the spacer frame the peripheral speed of the “spacer frame”, moved along its lower side by means of a gripping and transportation system, can be synchronised (and vice-versa) with that of the conveying belts or rollers situated on the sliding shoulders, in the instant where the spacer frame is rotated this cannot be achieved, the “spacer frame” speed varying linearly from nil value, in correspondence to the centre of rotation to a maximum value in correspondence to the extremity along the longest side; this implies a worsening situation in that, other than the contact between sealant and conveying belts or rollers, which is damaging in its own way, scraping also takes place, which is even more critical considering the damage this movement can create on the sealant. The local speeds (intended as vectors) of the “spacer frame” and of the motorised support means are, on the other hand, different not only in intensity but also in direction.

### SUMMARY OF THE INVENTION

The principal aim of the present invention is that of solving the technical problems highlighted, eliminating all the inconveniences referring to the state-of-the-art mentioned and therefore devising a procedure and an economical machine in view of the depreciation and in the running of the same, which can carry out the extrusion and the simultaneous application of sealant on the two lateral walls of a “spacer frame” for “insulating glass”, simply safely and automatically (or semi-automatically).

Furthermore, in an option which may be considered a little more complex for the machine, it can also allow “spacer frames” having shapes which are not rectangular to be processed, a task which is very difficult to obtain with the state-of-the-art machines.

For a clearer understanding of the philosophy of the machine of the present invention, the types of the processed product (“spacer frame” for “insulating glass”) have been previously described together with a summary of the sequence of procedures in order to obtain the same. Let us now observe, taking into consideration the procedure and machine which is the subject of this request, the specific stage whereby the sealing product is extruded (butyl-based material which is pumped by means of a volumetric measuring device) and the consequent regular application on the lateral faces of the “spacer frame”, carried out with alternate movements of the same “spacer frame” by means of transfer and rotation and by means of sealant extrusion without the same sealant, after being applied to the lateral faces of the “spacer”, getting into contact with any mechanism or part of the machine and therefore maintaining its uncontaminated integrity.

As explained above, it must be stressed that the sealant being a thermoplastic and tacky material and which is still hot, would be seriously damaged with any type of contact in that a thermo-plastic material is liable to deform according to the force applied in the contact and the time spent during contact (so-called viscous creeping phenomenon) whereby even a modest force intensity, yet acting on a discreet amount of time, can produce a damaging effect and its consequent deforming or even interruption endangering the principal quality required to the “insulating glass” which is that of air/gas tightness.

The basic scope of the invention is therefore that of not implying any type of contact, at least once the sealant has been applied. After decades of machine construction far from this principle, the concept, which is in itself simple, yet at the same time inventive, has been that of using the force of gravity to hold the “spacer frame” in a suspended position throughout the procedure of spreading, instead of a resting position.

The “spacer frame” is arranged, in a contained, recumbent position on the vertical base and hung in the proximity of one of its vertexes, on the machine, also known as the “butyliser”, which is able to apply the sealant, which is butyl. The loading of the machine can be carried out either manually or automatically in that a transporter/automatic feeder can link the machine which is the subject of this invention, with the machines prior to this machine such as the bending machine for bending hollow spacer bars to obtain the “spacer frame” and the filling of the hollow part of the “spacer frame” with hygroscopic material.

The essential and innovative principle on which the machine and the procedure is based on is made up, in its inventive extent (both extrinsic and intrinsic), by the fact of using the natural position imposed by the laws of gravity to avoid any kind of contact of those sides which have been spread with sealant with any elements which could damage the “virginity” of the same sealant and in its practical execution by the fact of having been able to create the movement of the spacer frame, the extrusion and the spreading of the sealant, maintaining the uncontaminated condition of the sealant once it is applied to the sides of the “spacer frame”.

The summarised description of the drawings and the detailed description of one of the ways of proceeding with the invention will make it clearer as to how it is possible to synchronise the transferring and rotating movements of the “spacer frame” and the pumping of the sealant (in symmetrical conditions along the two faces of the “spacer frame”) safeguarding the condition of avoiding any kind of contact of the applied sealant on the “spacer frame” with elements other than air.

The combination and synchronisation of the three motions described above, the transferring of the “spacer frame”, the rotation of the “spacer frame”, the pumping of the sealant can, at the same time carry out curved motions so as to allow the sealing of the so-called “shaped frames” that is, having a shape which is not rectangular.

### BRIEF DESCRIPTION OF THE DRAWINGS

FIG. 1 schematically represents the peripheral portion of the “insulating glass” in an exemplifying yet not exhaustive series of possible combinations: 1A normal, 1B triple glass, 1C stepped glass, 1D exterior laminated glass and low-E interior glass, 1E tempered reflective external glass with internal low-E laminated glass. The two types of sealant used are highlighted: the butyl sealant in black having the air/gas tightness quality (primary sealant) applied to the lateral surfaces of the “spacer frame” and the glass, in dotted-line the polysulphide, polyurethane or silicone sealants having mechanical resistance (secondary sealant) applied between the external surface of the “spacer frame”, including the part which may be in various forms and in connection to the lateral surfaces, and with the faces of the glass sheets right up to the edge of the same. The internal/external orientation is visually determined with icons that represent the Sun (exterior side) and the radiator (internal side).

The following figures are grouped together for working stages and, in the grouping of the same, the first (generally one or two) refer to principal views of the machine in its integrity whereas the following refer to the details and constructive mechanisms of the same and its state, as seen in the stage taking place at the time. In view of a descriptive summary, the word “spacer frame” will be used to indicate “spacer frame for insulating glass”.

FIGS. 2, 3, 4 represent the state of the machine and the state of the components involved in the stage of loading the “spacer frame” which is to be sealed.

FIGS. 5, 6, 7, 8 represent the state of the machine and the state of the components involved in the stage of the positioning of the “spacer frame” in correspondence to the extruding head.

FIGS. 9, 10, 11, 12 represent the state of the machine, the state of the components involved in the stage of “spacer frame's” rotation for its positioning, ready for initial sealing.

FIGS. 13, 14, 15 represent the state of the machine and the state of the components involved in the sealing stages of the first side of the “spacer frame”.

FIGS. 16, 17 represent the state of the machine and the state of the components involved in the rotational stage of the “spacer frame” for sealing in correspondence to the vertex of the “spacer frame” and for the positioning of the sealant on the next side of the “spacer frame”.

FIG. 18 represents the sealing product's measuring device in its double version.

FIGS. 19, 20 represent the state of the machine and the state of the components involved in the sealing stage of the second side (for the sealing of the subsequent vertexes and subsequent sides the corresponding previous figures are reiterated).

FIGS. 21, 22, 23, 24, 25 represent the state of the machine and the state of the components involved in the stage of supporting and transferring the “spacer frame” to the storage buffering rack.

FIGS. 26, 27 represent the state of the machine in the stage of depositing the “spacer frame” onto the storage buffering rack.

FIGS. 28, 29 represent the state of the machine while in continuous working order, that is, with a “spacer frame” in the loading stage, a “spacer frame” in one of the sealing stages, a “spacer frame” in the stage of being deposited on the storage rack, a series of “spacer frames” on the storage buffering rack.

FIG. 30 shows a possible solution of using the machine in the situation of a full insulating glass production line (as seen on the plan view).

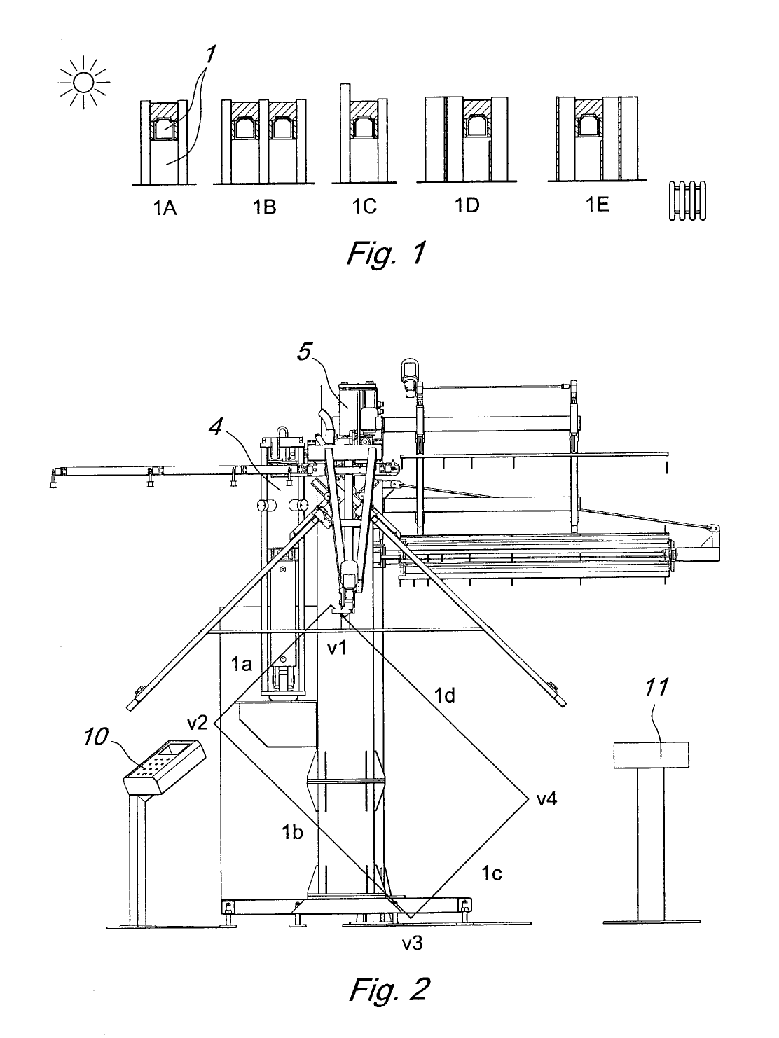

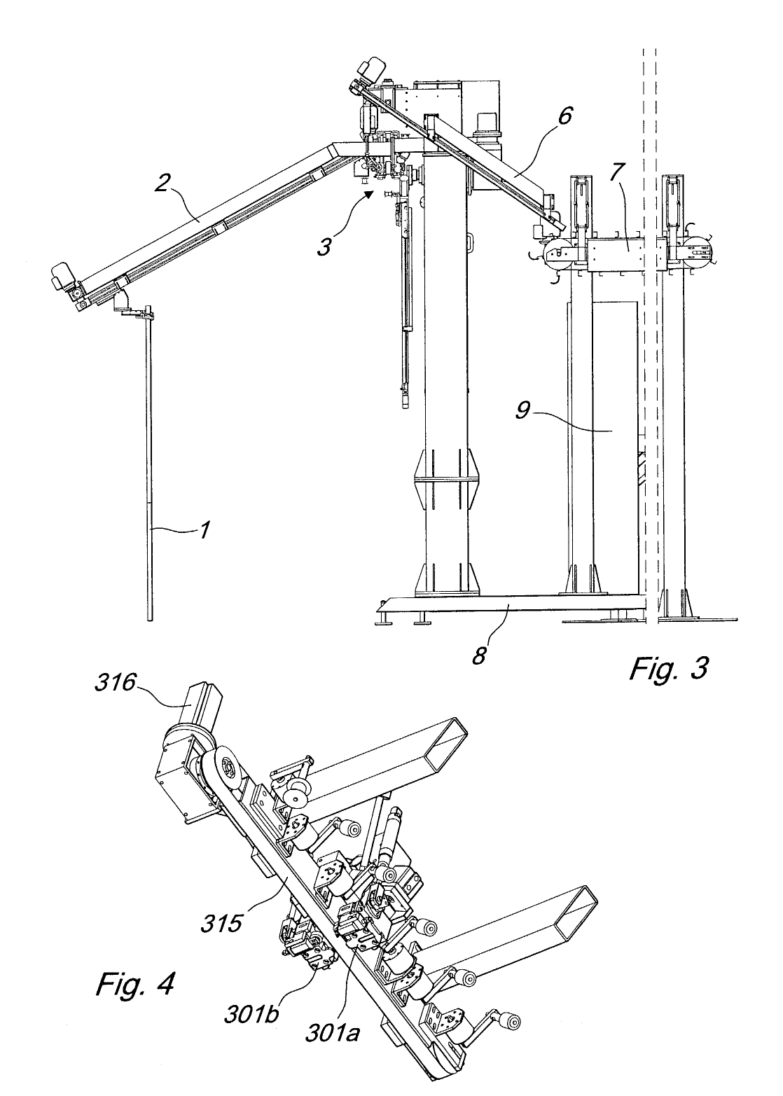

### DESCRIPTION OF THE PREFERRED EMBODIMENTS

Let us now come to the detailed description of one of the invention's achievements.

To better describe the implementation of the invention, including all the equivalents, reference is made to the relative figures and the essential configuration which has already been listed above, referring to possible alternative configurations which will be better defined in the claims, presenting, in the same sequence of figures, the stages of the functioning cycles and the mechanisms used, the state and the system of operating the same.

With reference to the figures, the principal group identifications are put forward (numbers beginning from 1) so as to have a global view, whereas the details and constructive mechanisms will be identified (numbers beginning from 201 of which the initial number refers to the group it belongs to) progressively during the description.

With 1 the “spacer frame for insulating glass” is identified, concisely called “spacer frame”, as derived from previous “origin” machinery which has implied its manufacture and its filling with hygroscopic material, made up of the sides 1a, 1b, 1c and 1d together with its vertexes v1, v2, v3 and v4.

With 2 the “transferring ramp” to the extruding head is identified (which can be interfaced with the machines earlier on in the process, in other instances referred to as “origin”).

With 3 the “extruding head” is identified.

With 4 the “melting chamber” of the sealant is identified.

With 5 the sealant “measuring device” is identified.

With 6 the “offloading ramp” to the storage buffering rack is identified.

With 7 the “storage buffering rack” is identified (which in the meantime can be interfaced with other machinery elsewhere called “destination”).

With 8 the “bedplate” of the machine is identified.

With 9 the “electric/electronic/pneumatic power board is identified.

With 10 the interface “console” with the operator is identified.

With 11 the “accident-prevention protection system” is generically identified.

The sequence of corners/sides in the process of being sealed is v1/1a/v2/1b/v3/1c/v4/1d/v1 or the reciprocal one in case of a mirror-view machine in respect to the version represented here, or a different version, for which this sequence would not be considered an essential aspect with regards to the inventive concept of the invention.

One of the invention's embodiments is explained as follows (for an easy understanding, it is sufficient to follow the figures at the same time in that the numbers of the components are recalled in the same sequence as they appear in the figures, with the logic of distribution in groups [1 or 2 characters] and sub-groups [3 or 4 characters]).

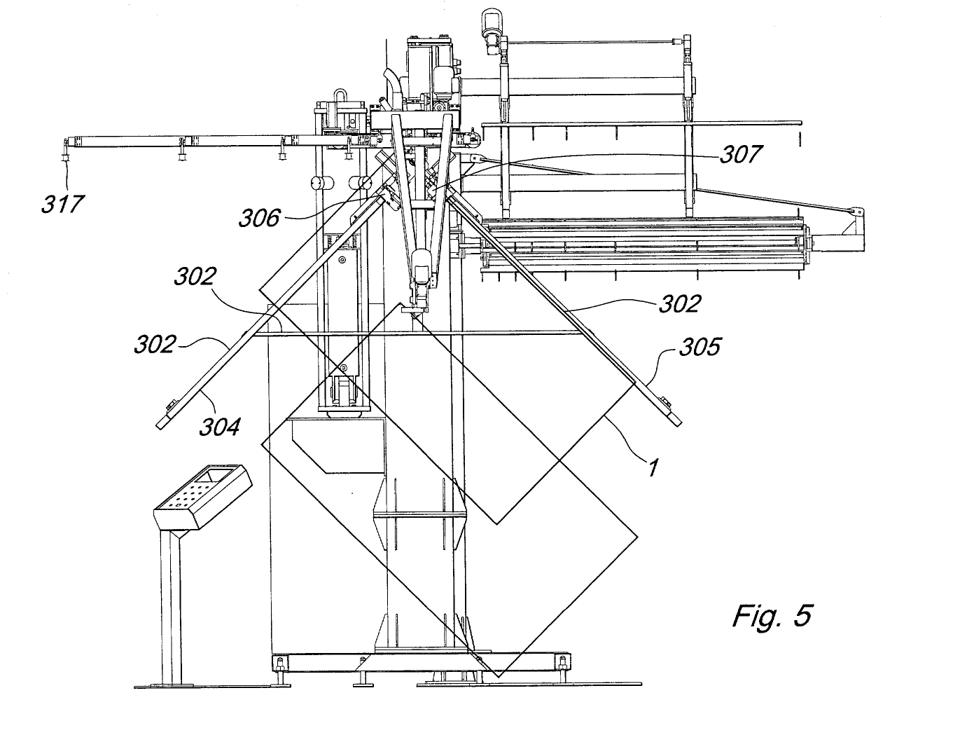

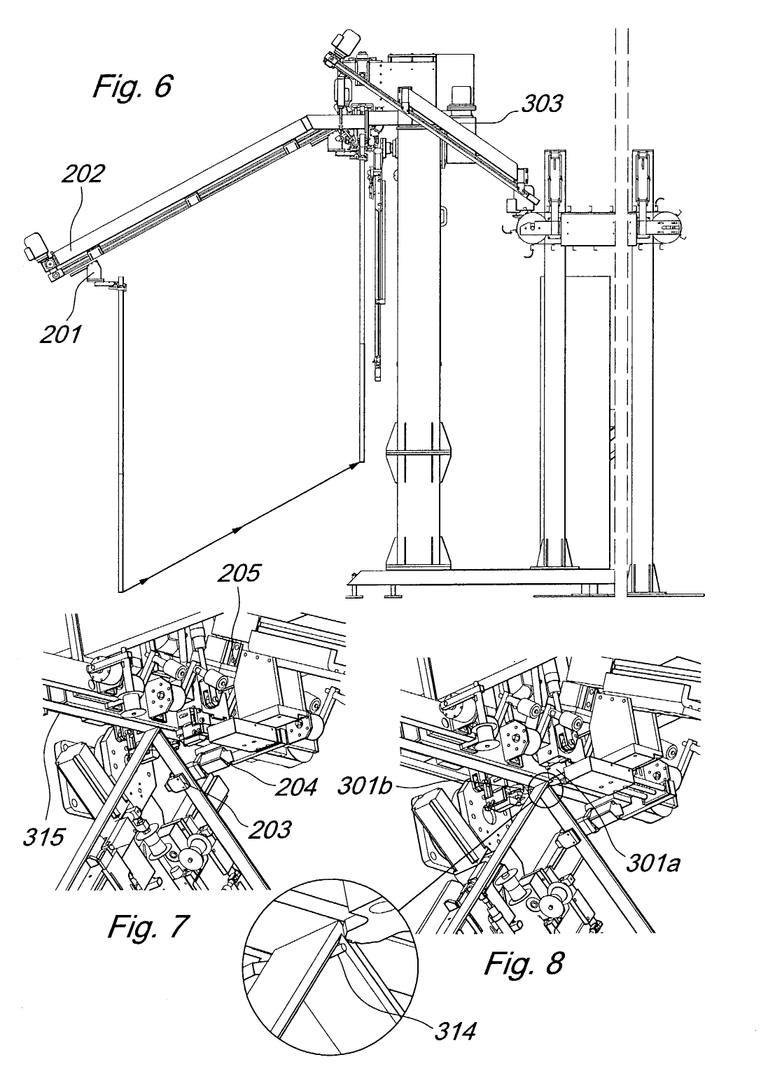

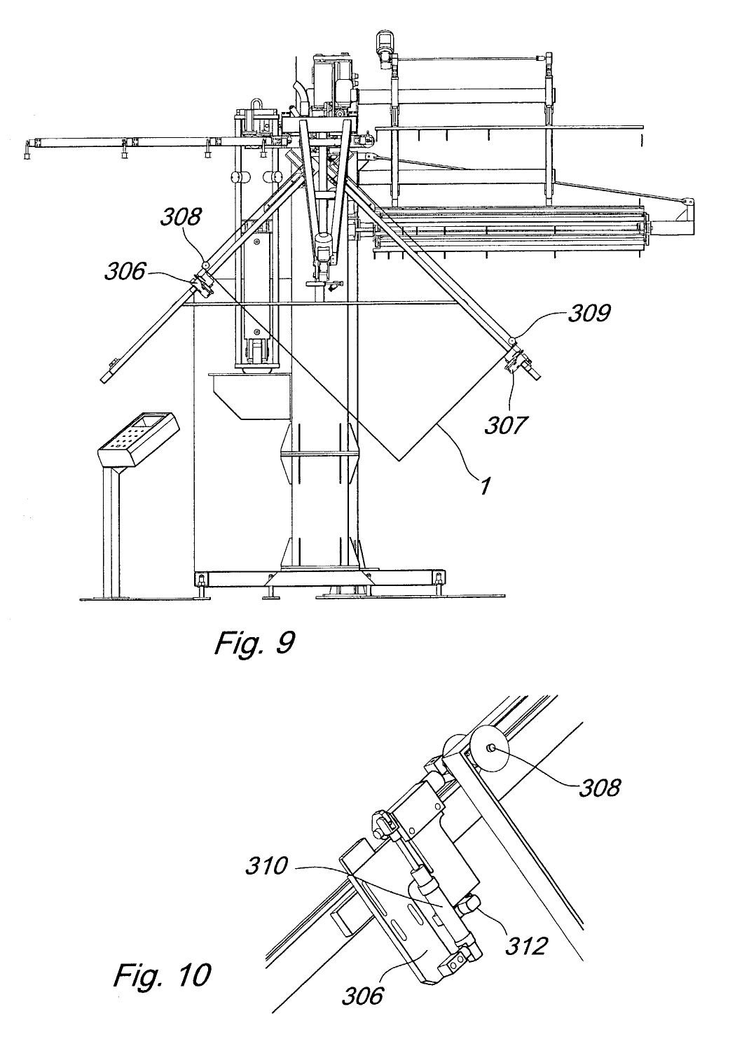

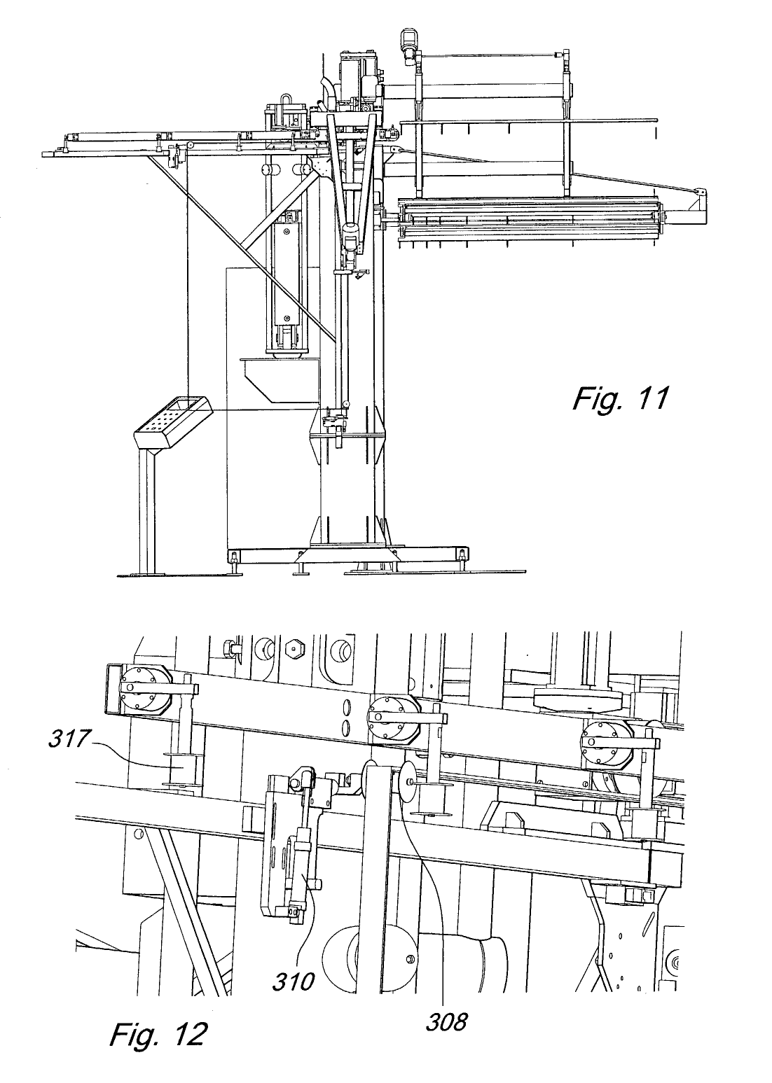

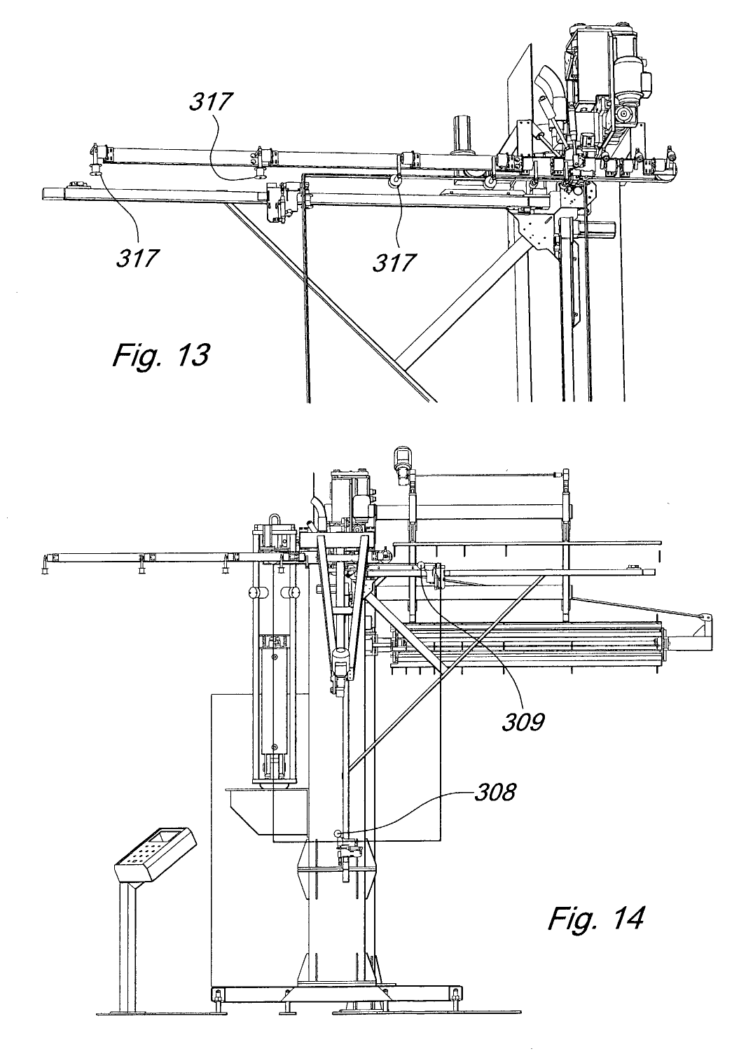

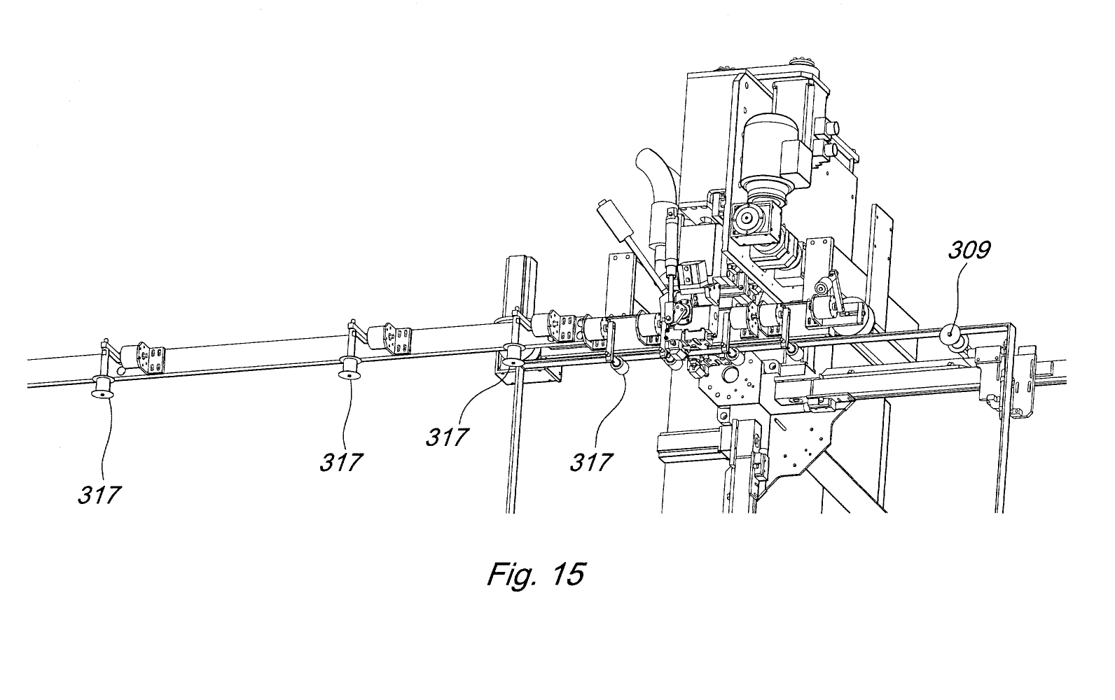

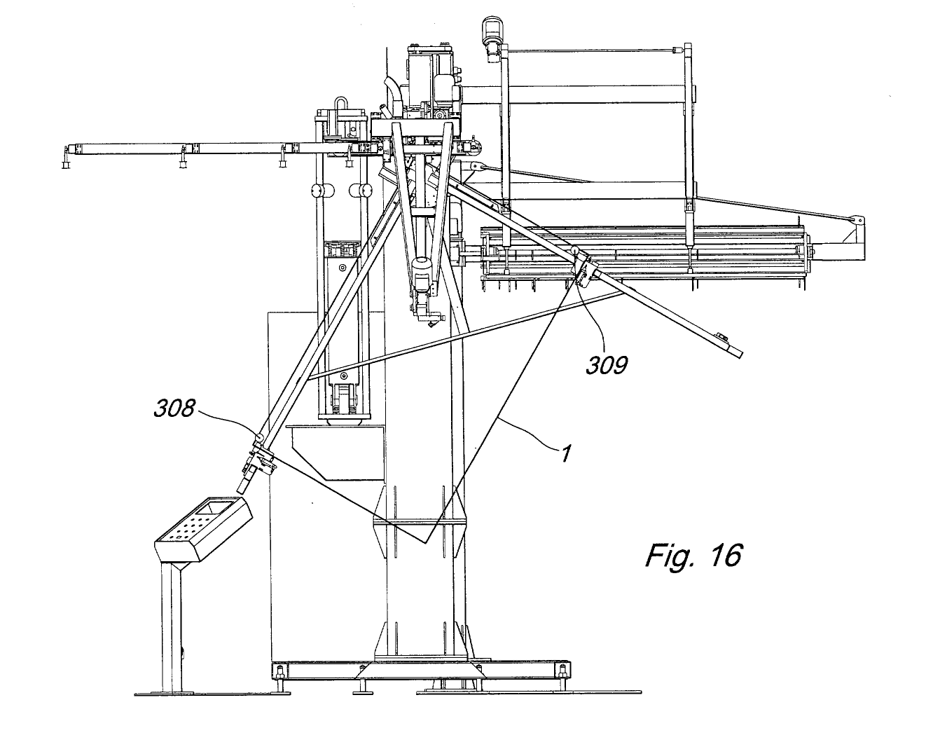

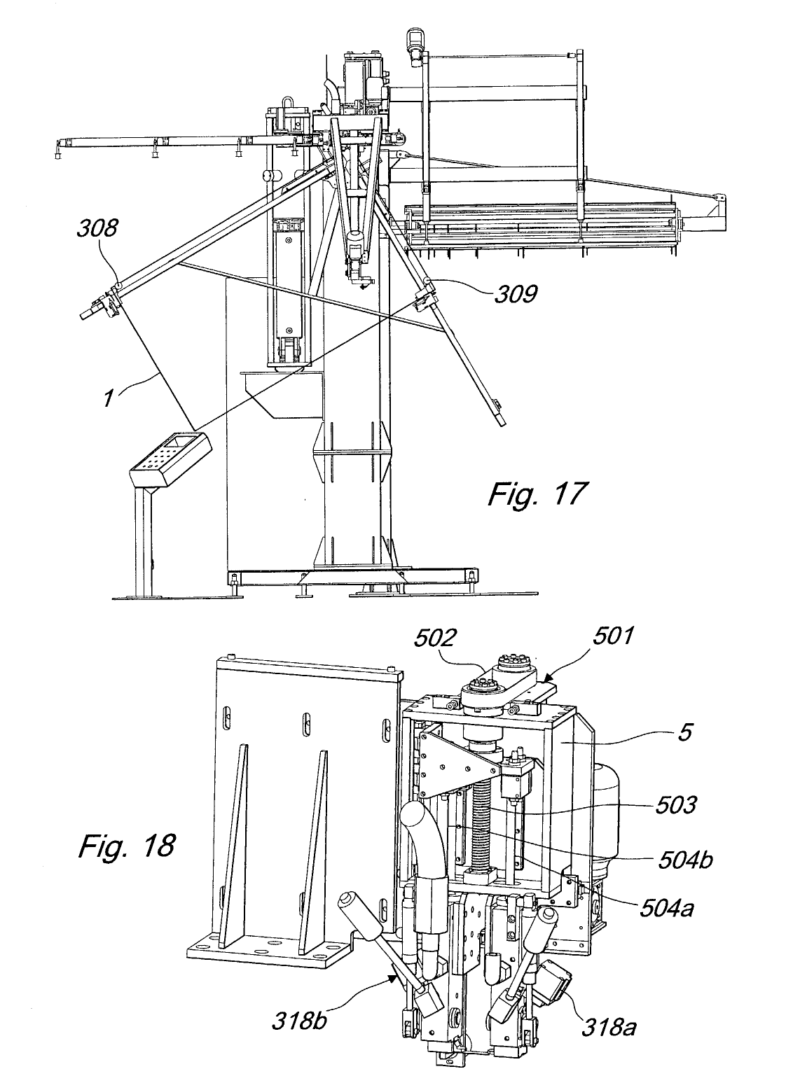

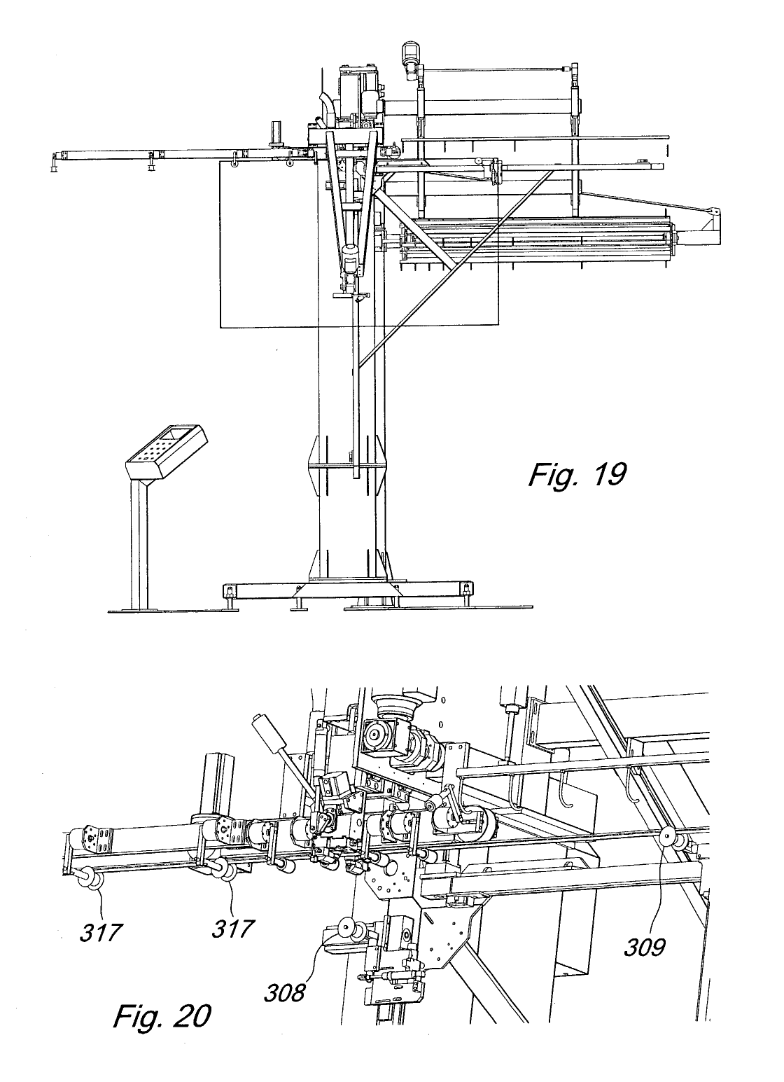

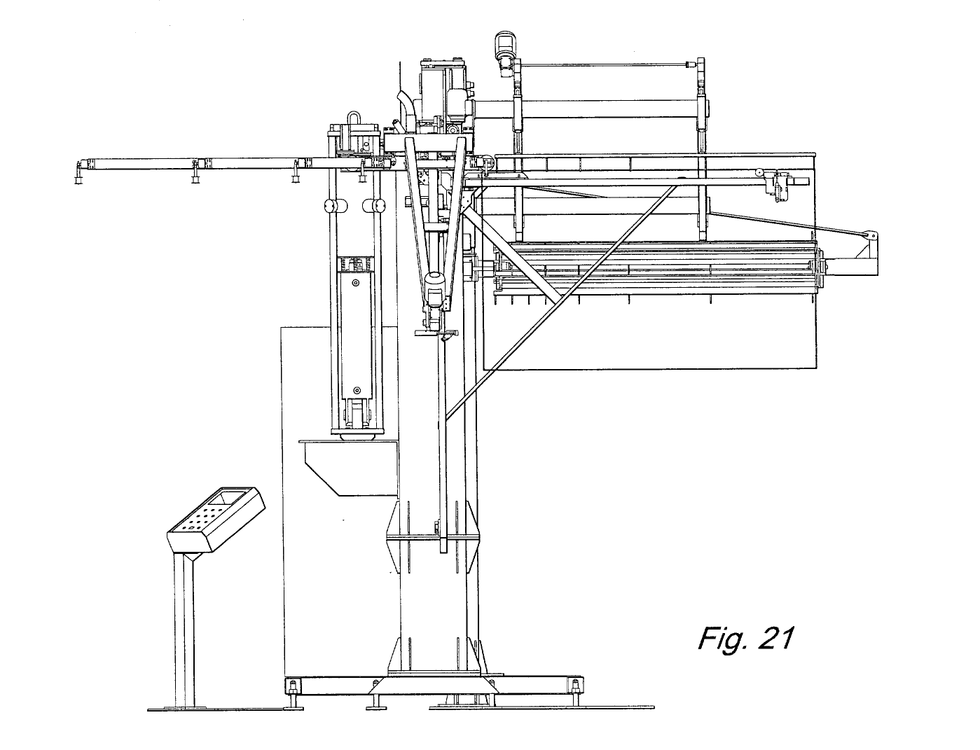

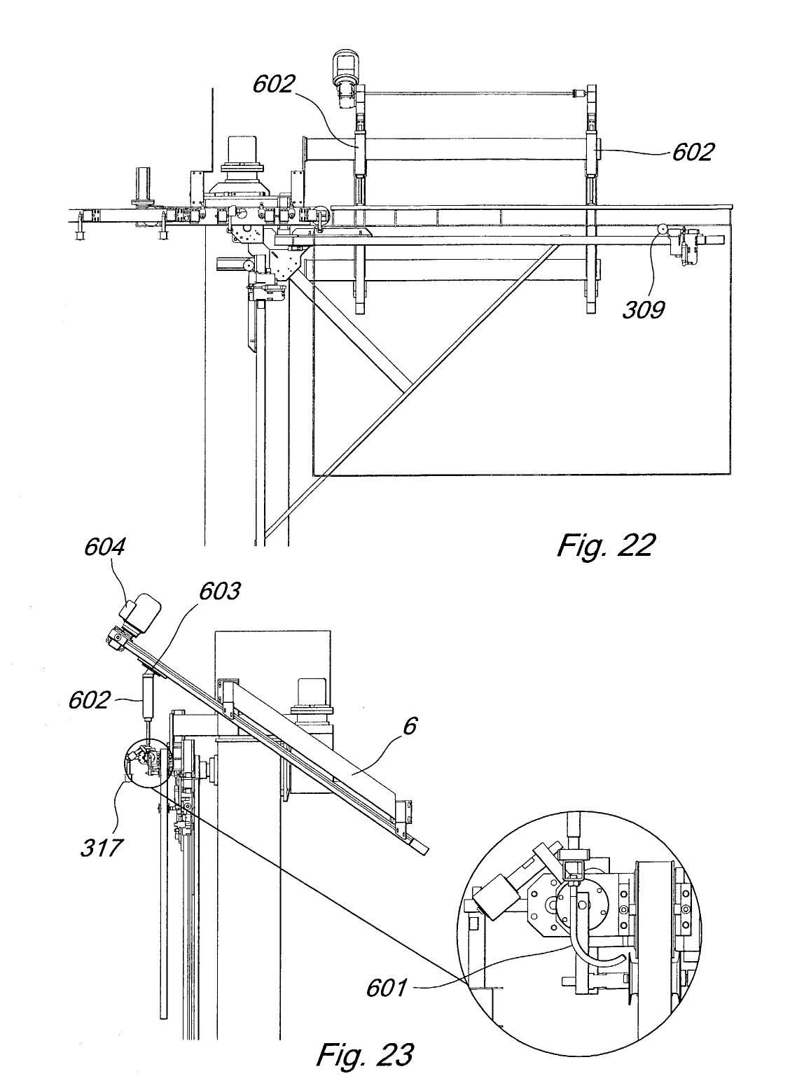

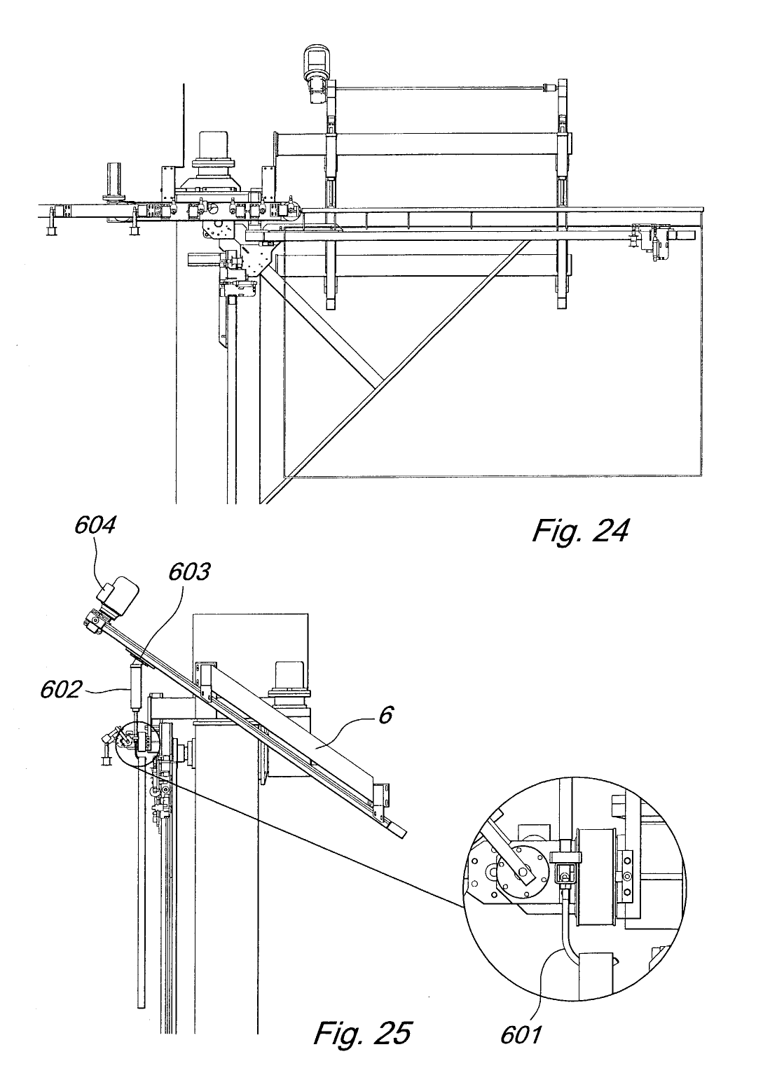

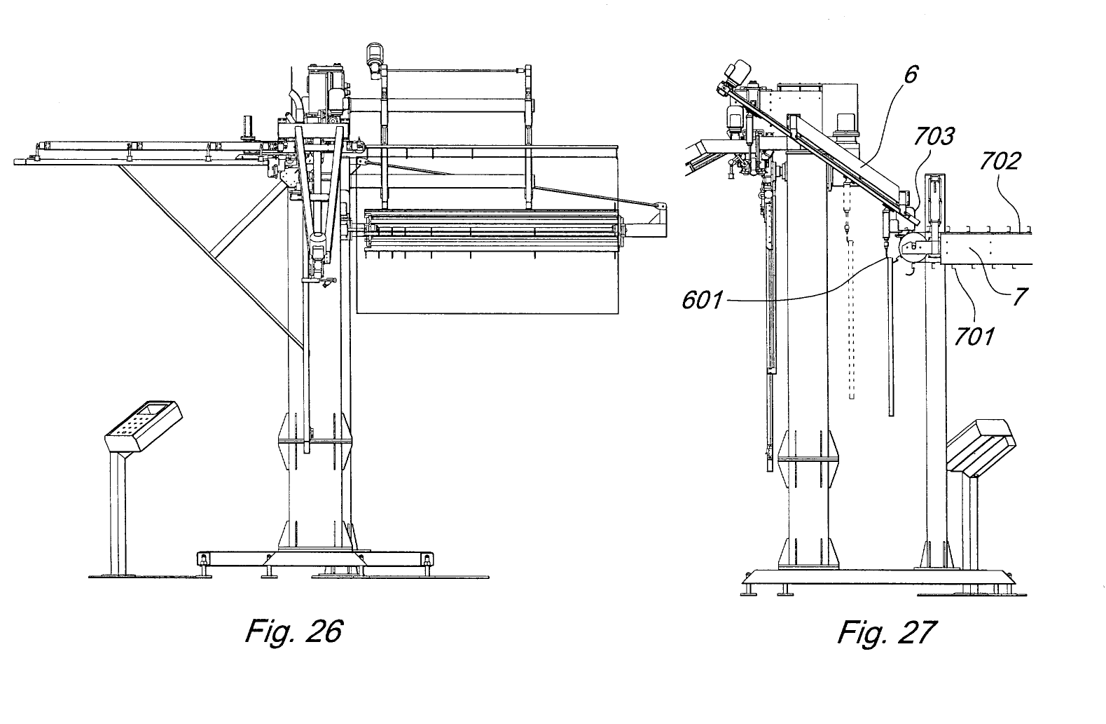

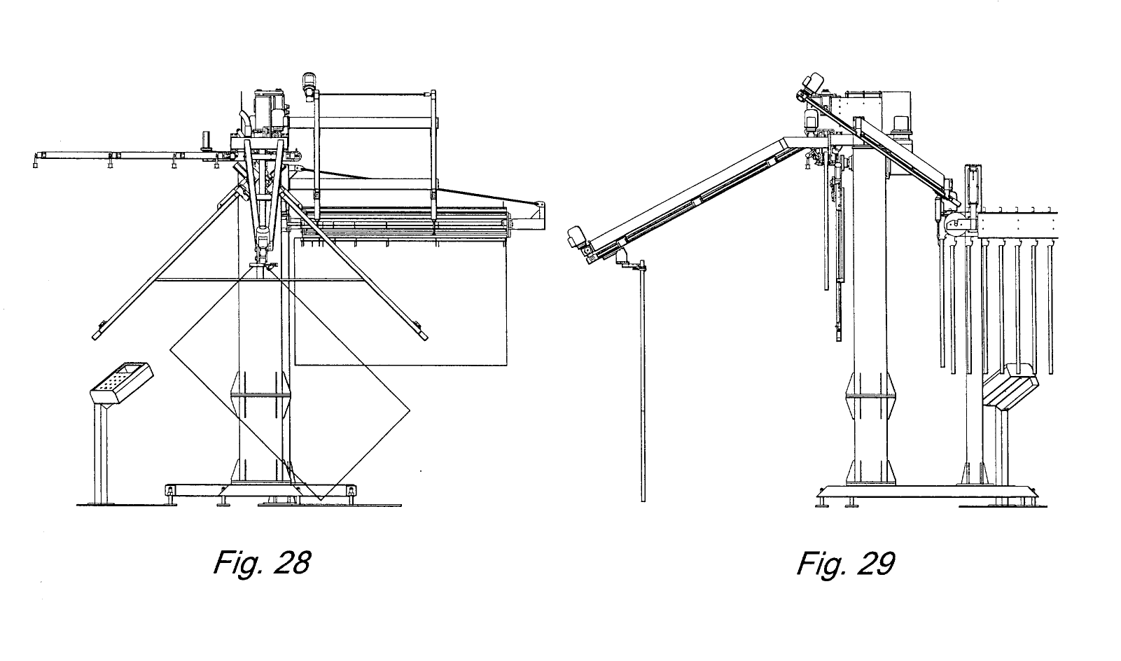

The “spacer frame” 1, clamped on the side 1d in correspondence to its vertex v1, runs up the “transferring ramp” 2 to be placed in correspondence to the nozzles 301a and 301b of the “extruding head” 3. The operations are carried out by means of a trolley 201, operated by a linear transporter 202, including the clamps 203 (operating on the two inner/outer walls of the “spacer frame” 1) operated by the pneumatic cylinder 204, supported at the same time by a pneumatically operated sliding element 205 which places the vertex v1 of the “spacer frame” 1 in correspondence to the self-centring nozzles 301a and 301b. The distance between the nozzles correspond to the thickness of the “spacer frame” 1 increased by the space required for the sealant and which is set by means of a self-centring mechanism, which has previously detected the frame width. The devices for self-centring and reading of the widths are those usually employed (and therefore being those which are well-known do not require a detailed description) on the butyl extruding machines belonging to the state-of-the-art. What has been noted as “extruding head” 3 includes, among its mechanisms, a rotating square 302, operated by a gear motor 303. The rotating square is formed by two arms 304 and 305 which at the same time mount motorised carriages 306 and 307 which respectively mount the free-running rollers 308 and 309, which are of the retracting type thanks to the use of pneumatic cylinders 310 and 311 (311 is not represented). In the case where we have left the “spacer frame” 1, lodged between the self-centring nozzles of the “extruding head” 3, the carriages 306 and 307 are found in their stationary position close to the vertex v1 of the “spacer frame” and the rollers 308 and 309 in a position of exclusion (FIG. 5). At this point the cycle proceeds with the following sequences: activation of the free-running rollers 308 and 309 to the point that both rollers come into contact with the respective internal faces of each side 1a and 1d of the “spacer frame” 1; rotation of the pivot pin 314 to a point where it interacts with the inner part of the vertex v1; sliding of the carriages 306 and 307 to the point where the rollers 308 and 309 reach the respective vertexes v2 and v4 of the “spacer frame” 1, or the end stroke of the same arms 304 and 305, should this be shorter than the relevant “spacer frame” 1 side, the closing down of the rollers 308 and 309 being determined by the interaction of the sensors 312 and 313 (313 is not represented) or by the limiting proximity switches placed on the same arms. In this standing, the “spacer frame” 1 is left free by the clamping device 203 and is only held by the pivot pin 314 in correspondence to the vertex v1 and to the rollers 308 and 309 in correspondence to the vertexes v2 and v4 respectively and by the force of gravity (primary inventive concept). The pivot pin 314, which acts as a hub during the “spacer frame's” 1 rotation, remains active throughout the whole sealing cycle in order to prevent the side of the frame and the vertex from moving away from the nozzles 301a and 301b. The rotating square 302 in its clockwise rotation brings the side 1a of the “spacer frame” 1 in direct contact with the transmission belt 315 operated by a gear motor 316, which at this point is deactivated. A series of free-running wheels 317, of the retracting type, part of which are placed in correspondence to the transmission belt 315 and part which are cantilevered in respect to the same transmission belt, are activated and close down in contact with the internal face of side 1a of the “spacer frame” 1. At this point the rollers 308 and 309 mounted onto the arms 304 and 305 of the rotating square 302 retract and the rotating square 302 accomplishes an anti-clockwise rotation of 90° (should there be rectangular frames in this case, without complicating this description so as to extend it to the so-called “shapes”, should these be polygonal or rounded or a combination of both, but imagining that the same inventive idea also covers the possibility of processing “shaped” frames, after applying the necessary constructive modifications, even if this is not simple) so as to bring its arm 305 into a horizontal position, ready for supporting the “spacer frame” when, during the sealing stage it will be transported to the right. During this rotation, the carriages 306 and 307 which include the rollers 308 and 309 retract to the stationary position towards the vertex of the same rotating square 302. In this condition the following actions are put into operation which are coordinated and concurrent and which foresee the spreading of sealant on the opposite faces of the side 1a of the “spacer frame” 1: opening of the sealant feed valves 318a and 318b leading to the nozzles 301a and 301b; activating of the “measuring device” 5 which, by means of the motor 501, the belt transmission 502 and the screw with re-circulating bearings 503, moves the syringe 504a and 504b which measure the sealant in volumes and feed it to the respective nozzles 301a and 301b; activation of the transmission belt 315, operated by the gear motor 316 which, in contrast to the free-running wheels 317 allows the controlled movement of the now horizontal side 1a of the “spacer frame” 1; therefore, as soon as the vertical side 1d of the “spacer frame” 1 goes beyond the rotating square's 302 arm 305 carriage 307 roller 309, the same roller 309 is rotated from its stationary position to the point of supporting the internal face of the “spacer frame” 1 side 1a during its movement towards the right hand side and moving with the same; in the meantime, immediately before their interference with the vertical side 1b of the “spacer frame” 1, the free-running rollers 317 return to their stationary position, due to a logic that recognises the position of the same vertical side from the combination of the measurements taken at the beginning by the roller 308 of the side 1a and by the feedback of the transmission belt 315 command motor 316. All these co-ordinated and concurrent actions, are governed by axis-controlled motors (respectively for the measuring device, the bogie, the arm and the transmission belt) and by a programmable logic controller (PLC). When the sealing of the first side 1a has been carried out, that is when the vertex v2 is in correspondence to the extruding nozzles 301a, 301b and the pivot pin 314 (this position being determined by the PLC based on the measurement of the length of the side 1a and by the feedback of the transmission belt 315 command motor 316 and, in any case re-controlled by a photocell placed in the immediate proximity) and the roller 309 together with the vertex v1 of the “spacer frame” 1 at the end of the run, the roller 308 moved by the current carriage 306 along the rotating square's 302 arm 304, reaches the vertex v3 of the “frame” 1. In these conditions, the pivot pin 314 which is still active acts as a hub along the vertex v2 and the whole rotating square 302 is rotated in a clockwise direction by 90° (this in the case of rectangular frames, without complicating this description by extending it also to the so-called “shaped” frames whether they are polygonal, rounded or a combination of both, but by imagining that the same inventive concept also covers the possibility of processing “shaped” frames, with the aid of a constructive modification, even if it is not simple) in order to bring the second side 1b of the “spacer frame” 1 in such a condition to initiate the sealing process. During the stage of “spacer frame's” 1 rotation, the sealant injection is either cut off or modulated in flow in view of the type of vertex of the same “spacer frame” 1: in the case of a clean vertex it might be better to close the flow of sealant by means of a valve 318a and 318b, in the case of a rounded vertex it would result necessary to control the flow of sealant by means of an adequate operation of the motor 501 which operates the syringes 504a and 504b, connected in electrical axis with the gear motor 303 which acts on the rotating square 302. A possible and very useful alternative, before initiating sealing on the following side, in that it can be parameterised by means of software, is that of excluding the pivot pin 314 and moving the frame backwards (movement towards the left for the machine which is being represented in the figures) in respect to the nozzles 301a and 301b by operating the transmission belt 315, so that the amount of sealant extruded on the subsequent side initiates beforehand, thus improving, in this way, the sealing of the corner.

The subsequent stages are nothing more than a repetition of the sequence as detailed above with the exception that, once the sealing of the side 1d has been completed, the valves 318a and 318b are closed, the measuring device 5 is cut off and the pivot pin 314 is deactivated. Therefore, by operating the conveyor belt 315 operated by a gear motor 316 and in contrast to the free-running wheels 317 placed to the right of the nozzles 301a and 301b, the “spacer frame” 1, its side 1d being included between the conveyor belt 315 and the free-running wheels 317 as mentioned above, is transferred in proximity of the “offloading ramp” 6, remaining in any case active, in order to support the same side 1d, the roller 309. At this point, the series of hooks 601 assembled on a horizontal bar fixed to the cylinders 602 which at the same time run on linear slides 603 operated by a gear motor 604, with a combined action of the cylinders 602 and other guide channels 603 position themselves in correspondence and beneath the side 1d of the “spacer frame” 1. The subsequent deactivation of the rollers 317 and the roller 309 releases the “spacer frame” 1 onto the series of hooks 601. At this point, by using the “unloading ramp” 6, the bar containing the hooks 601 which is mobile on the slides 603 operated by the gear motor 604 which accompanies the frame 1 to the “storage buffering rack” 7 where the hooks 701, driven by a transporting tape 702 operated by a gear motor 703, gather the “frame” 1 which falls in sequence with the others which have already been treated, for a stage to be interfaced with the following machine, as defined otherwise as being the “destination”.

Another essential characteristic, and which differs the invention from the pertinent state-of-the-art, is represented by the fact that the “measuring device” 5 is symmetric that is, it is capable of measuring the exact identical quantity of product on the two lateral opposite walls (faces) of the “spacer frame” 1. This is achieved with the double presence of the “measuring device”, for example by means of two syringes 504a and 504b each one of which works through its own chamber and with its own pipework and leading to its respective extruding nozzle (301a and 301b), with the wariness that the two conduits are to have lengths and diameters to include the same pressure drop, as for example if these conduits were to be identical and also by obtaining self-centring extrusion heads. The main protection on this type of measuring device is of no interest but a dependant protection of the primary claim is sufficient.

As in the state-of-the-art, the butyl sealing product, being a thermo-plastic product, is melted inside a “melting chamber” 4 which is heat and pressure regulated and therefore maintained thermostatically throughout its flow (however with the important difference that the invention also includes the “double measuring device” 5 while differing to the state-of-the-art, which only uses the melting heat and pressure regulated chamber but not the measuring device) right up to the nozzles 301a and 301b operating on the opposite lateral walls (faces) of the “spacer frame” 1.

In all the stages of horizontal transportation of the frame and rotation of the “frame”, the stage condition in respect to the “measuring device” which distributes the product is achieved by interconnected electronic drives.

The description above refers in itself to a machine in which the “origin” machine is placed in front, and the “destination” machine is placed behind; it is easy to imagine a description and relevant figures in the case where the position of the “origin” and “destination” machines are of any type.

Obviously all the connected movements to the stages of the cycle are interlocked, by means of a parallel yet always active logic, in order to avoid conditions of interference of the “spacer frame” with parts of the machine or parts of the machines between themselves. Likewise this logic controls the interface and the synchronism with the eventual previous working machine (as for example the machine which produces the spacer somewhere else said “origin”) and with the subsequent transferring machine (elsewhere called “destination”). This interface can be achieved by means of a type of “transfer” machine for the link between machine for the frame production and the machine, which is the subject of this invention, and the insulating glass production line.

This invention is open to numerous achievable variations (in respect to anything deducible from the designs, whose details are evident and eloquent) all of which are contained in the field of equivalency with the inventive concept, in this way for example the mechanical solutions for the rotation and the transportation of the “spacer frame” 1 the mechanical solutions for the support of the “spacer frame” 1, the operating means which may be electric, electro-electronic, pneumatic, hydraulic and/or combined, etc, the means of control which may be electronic or fluidic and/or combined, etc.

The constructive details can be substituted with others, which are technically equivalent. The materials and the dimensions can be of any type according to the requirements in particular deriving from the types and dimensions of the “spacer frames”.

Furthermore, the field of application may concern not only the “spacer frame” for “insulating glass” units but also any sector where there is a problem of spreading a product, which can be extruded onto an item evenly, bilaterally or unilaterally and of avoiding contact between the sealant and any other means other than air.

Generically with 11, the “protection structures” are indicated, be they of mechanical protection type or optical or laser barrier type which can be set up according around the area to be protected or electro-sensitive mats, etc., in that particular attention is dedicated, not only to the functional, economical and ergonomic aspects, being a part of the contents of this invention, but also including aspects on accident-prevention.

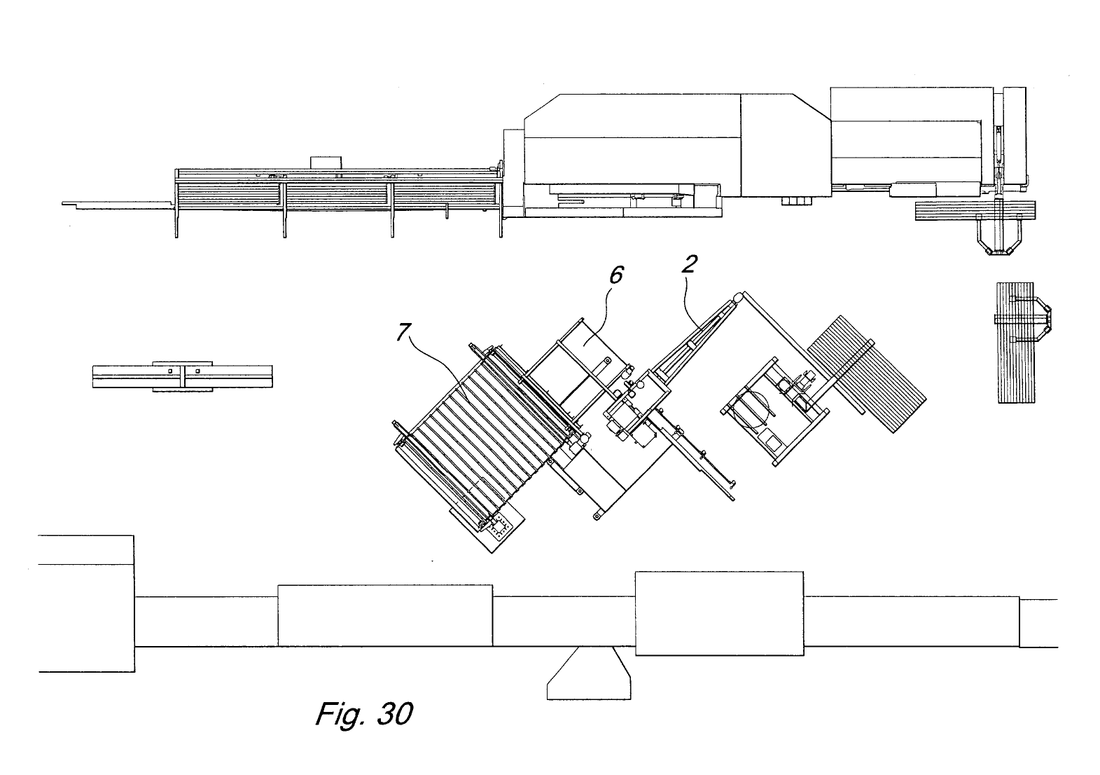

It is a given fact that the industrial application is bound to be successful in that the machines that carry out automatic or semi-automatic butylisation have been consolidated on the market for over twenty years, all of which operate on a principle which is far from the subject of this invention and with notable technical problems, as previously described in detail. Many of these machines have worked for many years and therefore have reached the end of their working life; all of them (and there are thousands) are, in any case, obsolete in the eye of the invention hereby presented. What's more, the market for “insulating glass” is in continuous expansion, and it is evident that new investments will be directed to the most recent and innovative technologies. The inclusion of this invention in the insulating glass production line is shown in FIG. 30, evidently confirming its guaranteed industrial application.

The disclosures in Italian Patent Application No. TV2001A000131 from which this application claims priority are incorporated herein by reference.

What is claimed is:

1) Automatic or semi-automatic machine for the extrusion and application of sealant on the two lateral walls of a spacer frame for insulating glass, wherein the spacer frame is held suspended only by its part (lengthwise side or corner) which is in the stage of spreading whereas the remaining part, in particular the part already spread with sealant, is suspended on a vertical base by the law of gravity and therefore does not come into contact with parts of the machine or other contaminating agents.

2) Machine according to claim 1, wherein with the combination of the three motions: linear transfer of the spacer frame, rotation of the spacer frame, pumping of the measuring device, it is possible to carry out curvilinear motions in order to achieve the sealing of the so-called shaped spacer frames, that is having a shape other than rectangular.

3) Machine according to claim 1, wherein the measuring device is symmetric, that is that the flow is identical for both nozzles opposite each other and each one acting on one of the walls (faces) of the spacer frame, not only by symmetry of the paths but also thanks to the employment of a double measuring device which brings the product to the nozzles by means of two separate volumetric measuring devices.

4) Machine according to claim 3, wherein each nozzle is fed by its own measuring device in such a way to apply the sealant with different flows onto the two walls (faces) or to apply the sealant on a single wall (face) of the spacer frame.

5) Machine according to claim 1, wherein it is equipped with a single measuring device to interact with a single wall (face) of the spacer frame.

6) Machine according to claim 1, wherein in order to seal the corner, the spacer frame is rotated according to a rotation axis which coincides with the centre of the curvature radius of the connection which forms the same angle.

7) Machine according to claim 1, wherein in order to seal the corner, the spacer frame, after having been rotated is transferred slightly backwards in the process of reaching the nozzles, by means of the transmission belt, so that the corner receives an additional amount of sealant, which can be registered by the software, in order to optimise the finish of the same corner.

8) Machine according to claim 1, wherein even spread is applied, bilaterally or unilaterally, to a product which can be extruded onto a manufactured item unlike the spacer frame for glass.

9) Automatic or semi-automatic method for the extrusion and application of sealant to the two lateral walls of a spacer frame for insulating glass, wherein the spacer frame is suspended only by its part (lengthwise or curvilinear side, corner) which is in the stage of spreading whereas the remaining part, in particular the part already spread with sealant, is suspended on a vertical base by the laws of gravity and therefore does not come into contact with parts of the machine or other contaminating agents.

10) Method according to claim 9, wherein by means of combining the three motions: linear transfer of the spacer frame, rotation of the spacer frame, pumping of the measuring device it is possible to achieve curvilinear motions, the sealing of the so-called shaped spacer frames, that is having a shape other than rectangular.
